(19) United States
(12) Patent Application Publication
(10) Pub. No.: US 2010/0127976 A1
(43) Pub. Date: May 27, 2010

(54) System and Method for Lighting Device Selection

(75) Inventors: Alexandra Anne Mathews, San Antonio, TX (US); Paul Vidal, Boerne, TX (US)

Correspondence Address: FULBRIGHT & JAWORSKI L.L.P., 600 CONGRESS AVE., SUITE 2400, AUSTIN, TX, 78701, US

(73) Assignee: LUCIFER LIGHTING COMPANY, San Antonio, TX (US)

(21) Appl. No.: 12/622,241

(22) Filed: Nov. 19, 2009

Related U.S. Application Data
(60) Provisional application No. 61/116,058, filed on Nov. 19, 2008.

(51) Int. Cl. G06F 3/033

(52) U.S. Cl. 345/157

(57) ABSTRACT

Methods, devices (such as computer readable media), and systems (such as computer systems) for providing an interactive display that allows a user to view a lighting effect provided by a lighting device in a display comprising a rendition of an environment incorporating the lighting device.

### CROSS-REFERENCE TO RELATED APPLICATIONS

This application claims priority to U.S. Provisional Patent Application Ser. No. 61/116,058 filed Nov. 19, 2008, entitled “System and Method for Lighting Device Selection”, the entire disclosure of which is specifically incorporated herein by reference.

### BACKGROUND OF THE INVENTION

A. Field of the Invention

The present invention relates generally to systems and methods for selecting lighting devices.

B. Description of Related Art

Existing examples of systems and methods for selecting lighting devices typically rely on text-driven searches or other similarly inefficient methods. Existing applications do not provide a visual indication of the lighting device, as well as the resulting lighting effect, as a feature of the searching system. Existing search tools are largely designed to cater towards lighting industry professionals (e.g., lighting consultants and engineers), rather than end users or others (e.g., architects or interior designers) that may not be familiar with terminology used to describe or specify lighting devices.

Such systems can be cumbersome to those users not familiar with industry or vendor terminology. For example, existing systems typically do not provide an interactive display that allows a user to see the lighting effects provided by lighting devices in conjunction with the terminology used to identify the lighting devices. Existing systems are often categorized by specific types or categories of lighting devices and therefore may not allow a user to easily evaluate lighting devices that are classified as being in different categories or types.

### SUMMARY OF THE INVENTION

Exemplary embodiments of the present disclosure comprise a targeted product search tool designed to aid a user in finding an appropriate lighting device for the user's desired lighting application. Certain embodiments may comprise systems configured to operate with Adobe® Flash® Media software.

Exemplary embodiments provide a visual aid to a user throughout the searching process, rather than relying on text driven search processes. Exemplary embodiments provide users a graphical representation of specific lighting techniques, uses, and products as they navigate the search process. Such features can allow users (those both familiar and unfamiliar with a particular product line, or lighting industry terminology in general) the ability to navigate a search of various lighting devices to find the device that most appropriately suits their needs.

Exemplary embodiments comprise the use of virtual environmental renditions as visual aids to the vernacular text/terminology in the given step of the search. The environmental renditions may at first serve as static visual examples of broader lighting industry terms, for example, “wallwashers” and “cove lighting”. The process of pairing text with renditions empowers users not familiar with common industry terms to successfully navigate the search tool. In addition, certain embodiments may comprise a component whereby when the user scrolls over a specific option (e.g., fixed, adjustable, wallwash, round/square, domestic/international, etc.), a text box will appear to explain why that option could be chosen. This feature can make the system not only easier to use, but also educational in terms of the constraints, limitations and possibilities of all criteria that makes a fixture unique.

Subsequently the renditions become dynamic environments, which the user may “mouse-over” (e.g. manipulate an input device to position a cursor) to activate virtual lighting examples. Within each environment are multiple “on/off” bounded sections. A user can switch the virtual lighting “on” (e.g., the lighting effect can be displayed) if the cursor is within the specified boundary or if the cursor is over the paired text. The virtual lighting is switched “off” (e.g., the lighting effect will not be displayed) if the cursor leaves the bounded section or is no longer over the paired text. Certain embodiments also provide the user with a graphic or thumbnail image of a product being found by the search. As the search becomes more targeted, images of, or representing products are eliminated as those particular products fail to meet the users search criteria. In steps following the virtual environment process, the user may be provided with an image(s) and model number(s) of current results. The user is able to visually see the amount of found results, as well as make distinctions and connections between product lines and nomenclature (including industry or vendor-specific terminology), as well as judge the products aesthetically as they progress through the search; effectively allowing them to “window shop”. Existing search tools typically require the user to leave the search tool in order to see product images. Consequently, judging the product aesthetically comes after the search and denies this aspect of the user's judgment as they search. The process of combining aesthetic judgment in real time with the search process provides an efficient and effective system and method for searching for and selecting lighting devices.

Exemplary embodiments of the system and method provide for a visually rich search experience in addition to the descriptive text. Exemplary embodiments use virtual environment renditions as static and dynamic visual aids to the vernacular text and terminology. While static, the renditions serve as visual examples of broader lighting industry terms. While dynamic, the virtual environments react to cursor location allowing users to switch virtual lighting “on/off” by moving the cursor over specific sections or text. In subsequent steps, users are provided images and part numbers of current results in real time as they narrow their search.

Exemplary embodiments may also allow a user to expedite their ordering process through the system via an online ordering process. Exemplary embodiments may also comprise a custom specification generator which would actually create a specification sheet tailored to the user's preferences regarding available options which they would narrow down in the system.

In certain exemplary embodiments, once the user is directed to a product page for the specific fixture he or she has chosen, one or more real life applications will be displayed. Such applications may be identified with the project name, location and/or designers(s) that feature installed, real world versions of the product the user has selected.

A log-in system may be utilized to allow searches to be saved for future reference/orders for registered users. Exemplary embodiments may also comprise a photometry viewing application into the system, either linked from within the system or an integral part of it. In certain embodiments, the virtual lighting examples (i.e. the pattern and intensity of light the user sees in the rendition) can be changed depending on the lamp model selected. Such examples could be modeled using actual photometry data from testing, thus giving the user a much more lifelike example of the lighting compared to a viewing program alone.

In certain embodiments, the system takes the user to a general product page, and from there they can go to a static specification sheet and proceed with the ordering process. In specific embodiments, the user can go directly from the selection system into the ordering process, directly from selection system to a custom specification sheet, directly from selection system to a search profile, and further manipulate the selection system's environments via photometry choices.

Certain embodiments comprise a computer system configured to provide: an interactive display; a cursor; a lighting device designation; and an environmental rendition. In particular embodiments, the interactive display is configured to display a lighting effect; the lighting effect is displayed when the cursor is in a first position; and the lighting effect is not displayed when the cursor is in a second position. In certain embodiments, the first position is proximal to the lighting device designation. In particular embodiments, the first position is proximal to an area where the lighting effect will be displayed. In specific embodiments, the first position is proximal to either the lighting device designation or to the area where the lighting effect will be displayed.

In certain embodiments, the lighting device designation is part of a listing of a plurality of lighting device designations. In specific embodiments, the interactive display is configured to display a plurality of lighting effects. In certain embodiments, the system is configured such that a user can select the lighting device designation to view a specification display comprising a set of specifications regarding a plurality of lighting devices corresponding to the lighting device designation. In particular embodiments, the system is configured such that a user can select certain specifications to reduce the number of lighting devices in the plurality of lighting devices corresponding to the lighting device designation.

Certain embodiments comprise a computer system configured to provide: a first interactive display including a cursor and a designation for a category of lighting devices; and a second interactive display providing a rendition of an environment. In specific embodiments, the second interactive display is displayed when a user positions the cursor proximal to the category of lighting devices and selects the category of lighting devices; the second interactive display comprises a lighting device designation; and the second interactive display is configured to display a lighting effect from a lighting device, where the lighting effect is displayed when the cursor is in a first position and wherein the lighting effect is not displayed when the cursor is in a second position.

In particular embodiments, the first position is proximal to the designation corresponding to a lighting device. In certain embodiments, the first position is proximal to an area where the lighting effect will be displayed. In specific embodiments, the first position is proximal to either the designation corresponding to a lighting device or to the area where the lighting effect will be displayed.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Any embodiment of any of the system disclosed in the specification may consist of or consist essentially of—rather than comprise/include/contain/have—the described elements and/or features. Thus, in any of the claims, the term “consisting of” or “consisting essentially of” may be substituted for any of the open-ended linking verbs recited above, in order to change the scope of a given claim from what it would otherwise be using the open-ended linking verb.

The term “coupled” is defined as connected, although not necessarily directly, and not necessarily mechanically.

The terms “a” and “an” are defined as one or more unless this disclosure explicitly requires otherwise.

The terms “substantially,” “approximately,” “about,” and variations thereof are defined as being largely but not necessarily wholly what is specified, as understood by a person of ordinary skill in the art. In one non-limiting embodiment, the term substantially refers to ranges within 10%, preferably within 5%, more preferably within 1%, and most preferably within 0.5% of what is specified.

Furthermore, a device or structure that is configured in a certain way is configured in at least that way, but it may also be configured in ways other than those specifically described.

Other objects, features and advantages of the present invention will become apparent from the following detailed description. For purposes of clarity, not every feature shown in each view is labeled with an reference number. It should be understood, however, that the detailed description and the examples, while indicating specific embodiments of the invention, are given by way of illustration only. Additionally, it is contemplated that changes and modifications within the spirit and scope of the invention will become apparent to those skilled in the art from this detailed description.

### BRIEF DESCRIPTION OF THE DRAWINGS

The following drawings illustrate by way of example and not limitation. Every feature of a given structure is not always labeled in every figure in which that structure appears, in order to keep the figures clear.

FIGS. 1A-1G are displays of environmental renditions and various categories of lighting devices provided by a lighting device selection system according to exemplary embodiments of the present disclosure;

FIG. 2 is a display of an environmental rendition and designations for various examples of lighting devices for a category of lighting device, according to exemplary embodiments of the present disclosure;

FIGS. 3A and 3B are displays of an environmental rendition with a lighting device in an illuminated condition to provide a lighting effect, according to exemplary embodiments of the present disclosure;

FIGS. 4A and 4B are displays of an environmental rendition with a lighting device in an illuminated condition to provide a lighting effect, according to exemplary embodiments of the present disclosure;

FIGS. 5A and 5B are displays of an environmental rendition with a lighting device in an illuminated condition to provide a lighting effect, according to exemplary embodiments of the present disclosure;

FIGS. 6A, 6B, and 6C are a display of specifications and examples of specific lighting devices; and

FIG. 7 is a display of specifications and an example of a specific lighting device.

### DESCRIPTION OF ILLUSTRATIVE EMBODIMENTS

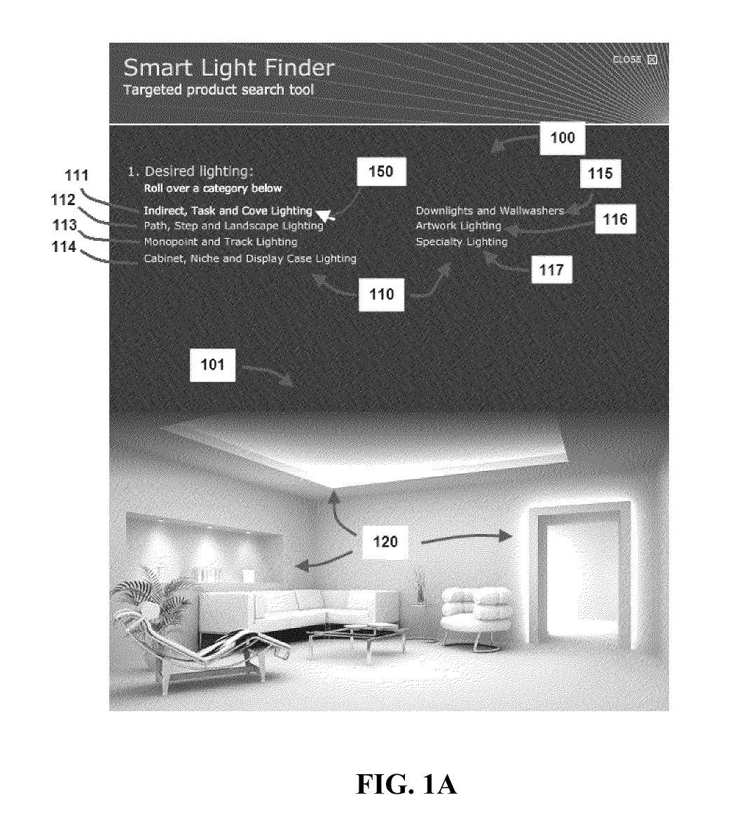

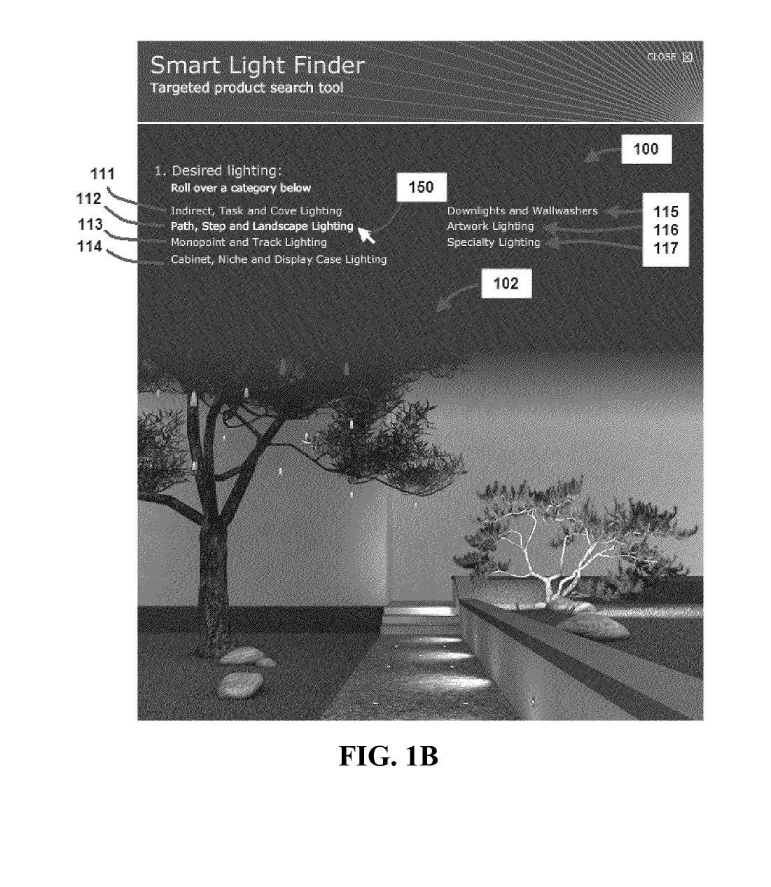

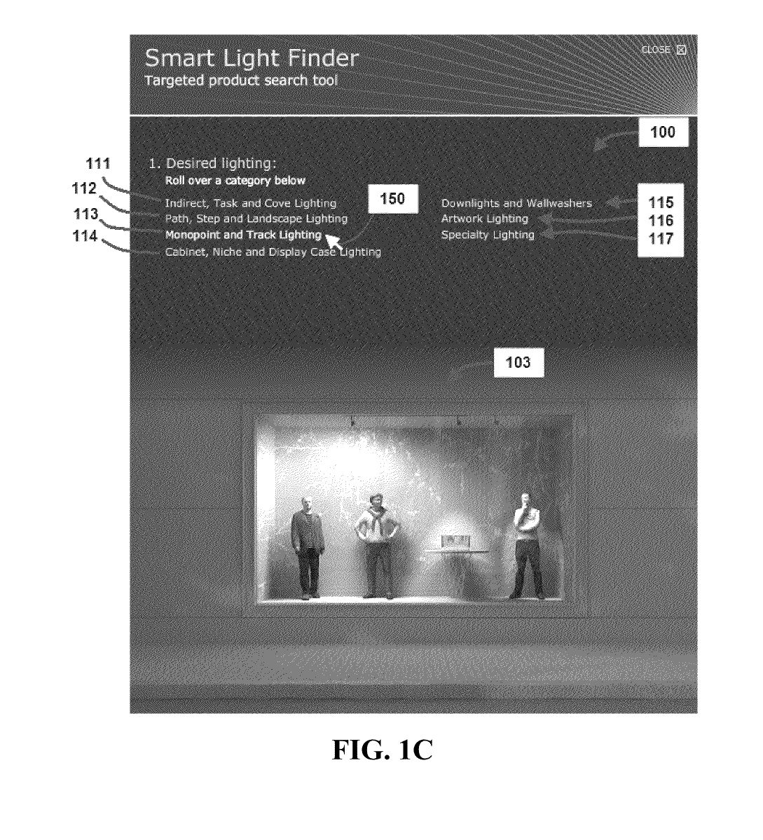

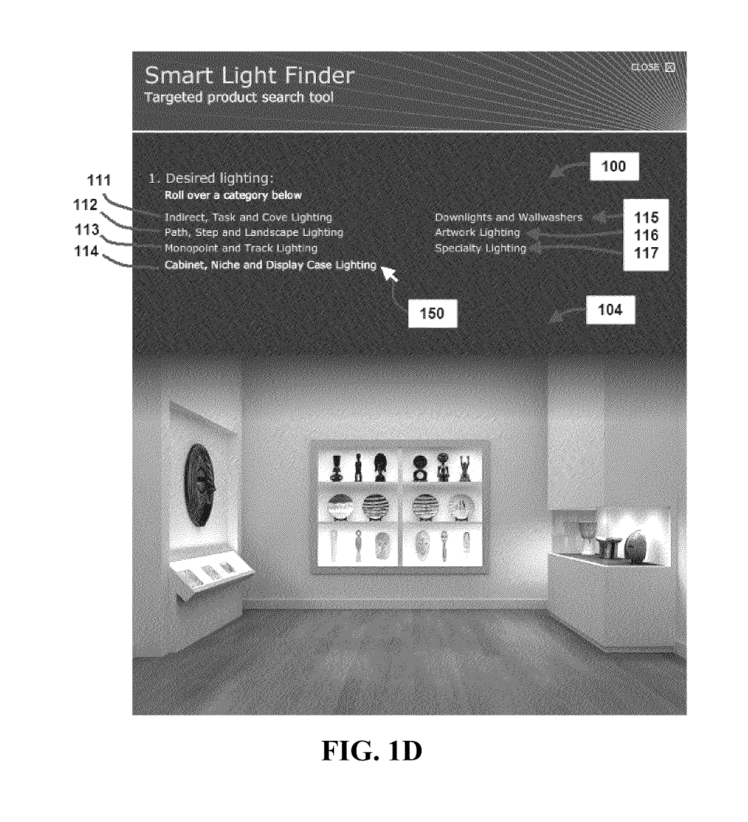

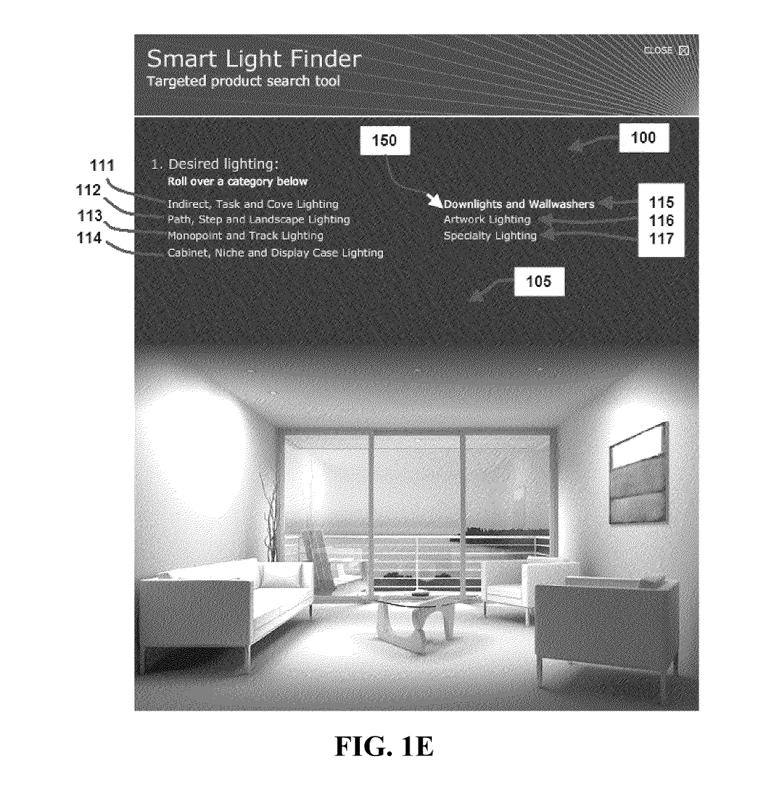

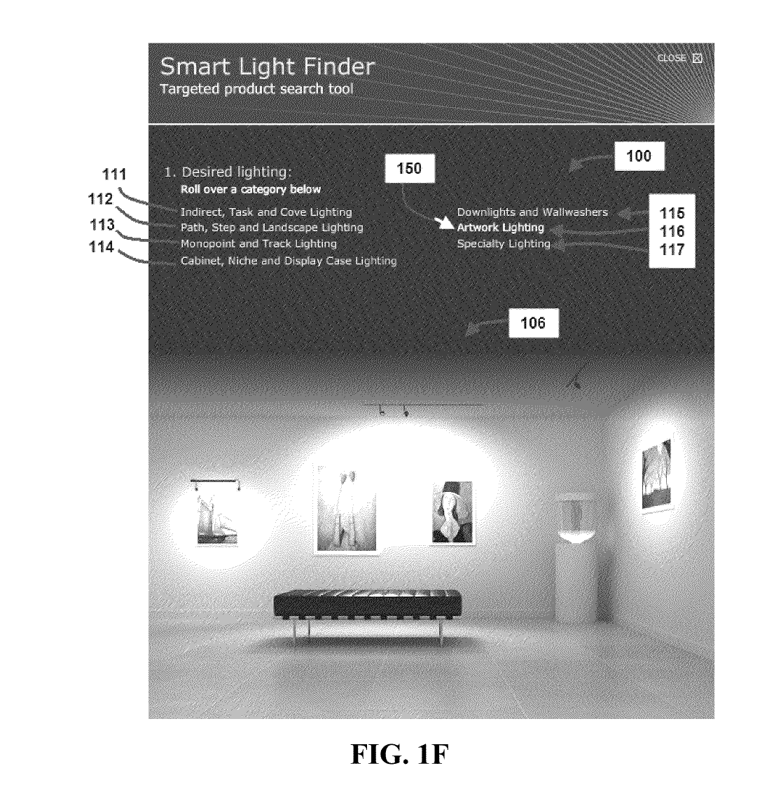

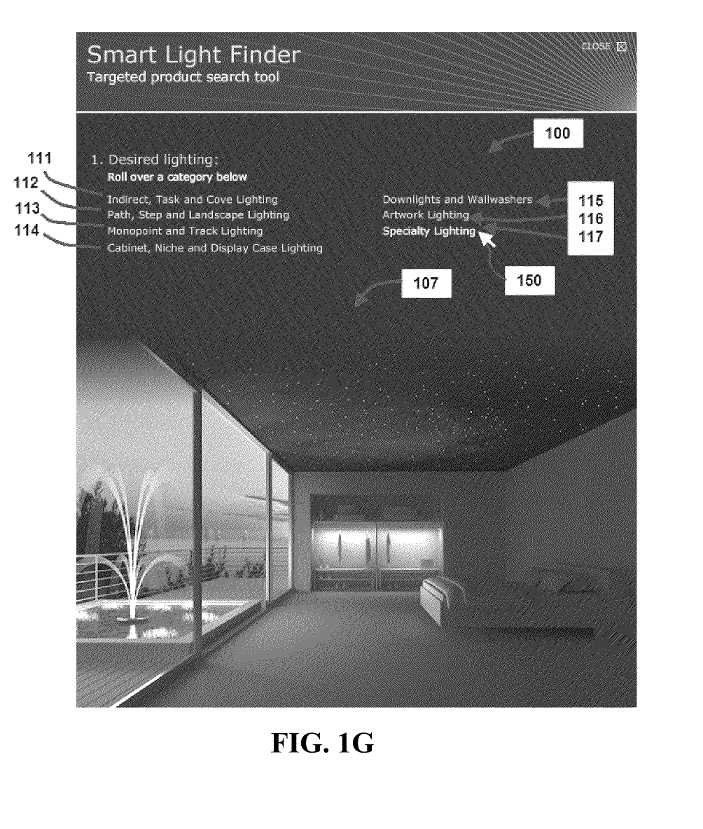

Referring now to FIG. 1, an exemplary embodiment provides an interactive display 100 that includes a listing 110 of lighting device categories and a visual indication 120 of various lighting effects. In the embodiment shown, listing 110 comprises a category 111 for “Indirect, Task, and Cove Lighting”, a category 112 for “Path, Step, and Landscape Lighting”, a category 114 for “Monopoint and Track Lighting”, a category 115 for “Downlights and Wallwashers”, a category 116 for “Artwork Lighting” and a category 117 for “Specialty Lighting”. It is understood that other embodiments may include different categories or combinations of categories of lighting devices.

In the embodiment shown, a user may direct an input device (such as a mouse, touchscreen, or touchpad) so that a position indicator or cursor 150 is located proximal to a specific category in listing 110. In FIG. 1A, a user has placed cursor 150 proximal to category 111 (for “Indirect, Task, and Cove Lighting”). When cursor 150 is located proximal to a category, interactive display 100 provides a display 101 illustrating examples of lighting effects provided by lighting devices for that category. Display 101 provides a view of the lighting effects provided by the lighting devices in a rendition of a typical environment in which the lighting devices would likely be placed or used. In the exemplary embodiment shown, a lighting effect for each lighting device (for the category of lighting device near the cursor) is displayed is displayed in display 101.

A user can view a different display by moving cursor 150 to an area proximal to a different category. For example, in FIG. 1B, a user has moved cursor 150 to an area proximal to category 112 (for “Path, Step and Landscape Lighting” in this embodiment). In response to cursor 150 being placed proximal to category 112, interactive display 100 provides an environmental rendition 102 that shows a rendition of an environment typical for lighting devices representative of category 112. In the manner described above, a user can move cursor 150 to an area proximal to category 113, 114, 115, 116, and 117 to view environmental renditions 103, 104, 105, 106 and 107 (shown in FIGS. 1C, 1D, 1E, 1F, and 1G, respectively).

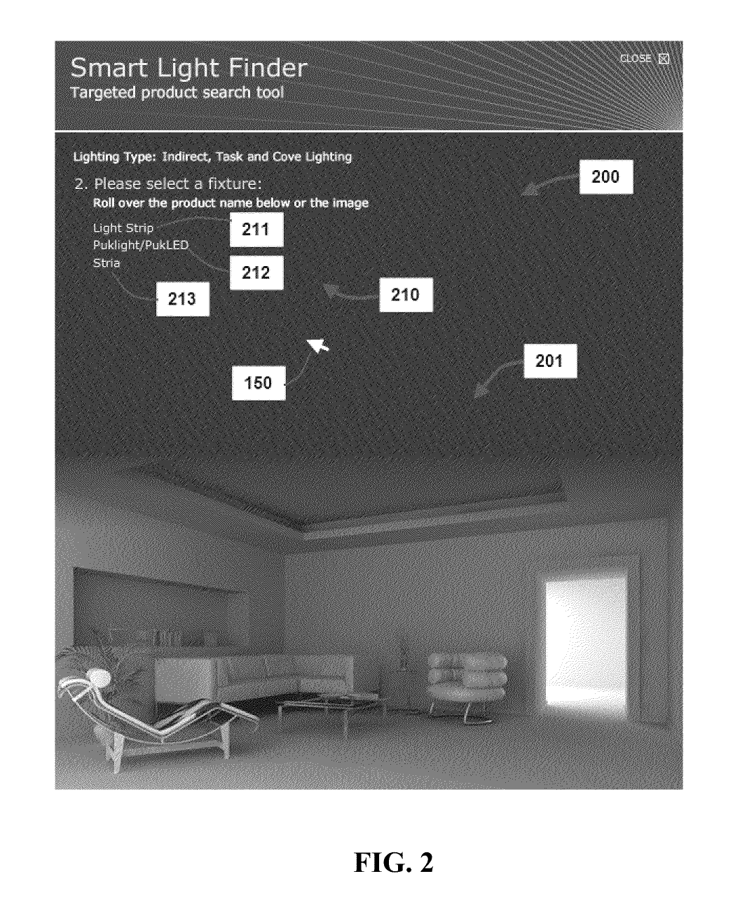

A user may select a category, for example, by clicking on a mouse or tapping a touchpad, after directing cursor 150 to an area proximal to a desired category. In certain embodiments, cursor 150 may change appearance (e.g., from an arrow to a depiction of a hand pointing a finger) to indicate that the user may use cursor 150 to make a selection. When the user selects a category, interactive display 100 is replaced with an interactive display 200, as shown in FIG. 2. Interactive display 200 provides a listing 210 of designations corresponding to specific types or names of lighting devices for the selected category. If a user selects category 111 for “Indirect, Task and Cove Lighting” from interactive display 100 in FIG. 1, the system will replace interactive display 100 with an interactive display 200 that includes a listing 210 that includes a designation 211 for “Light Strip”, a designation 212 for “Puklight/PukLED”, and a designation 213 for “Stria”. Interactive display 200 will also comprise an environmental rendition 201 that is similar to environmental rendition 101; however, environmental rendition 201 initially does not display the lighting effects of the lighting devices.

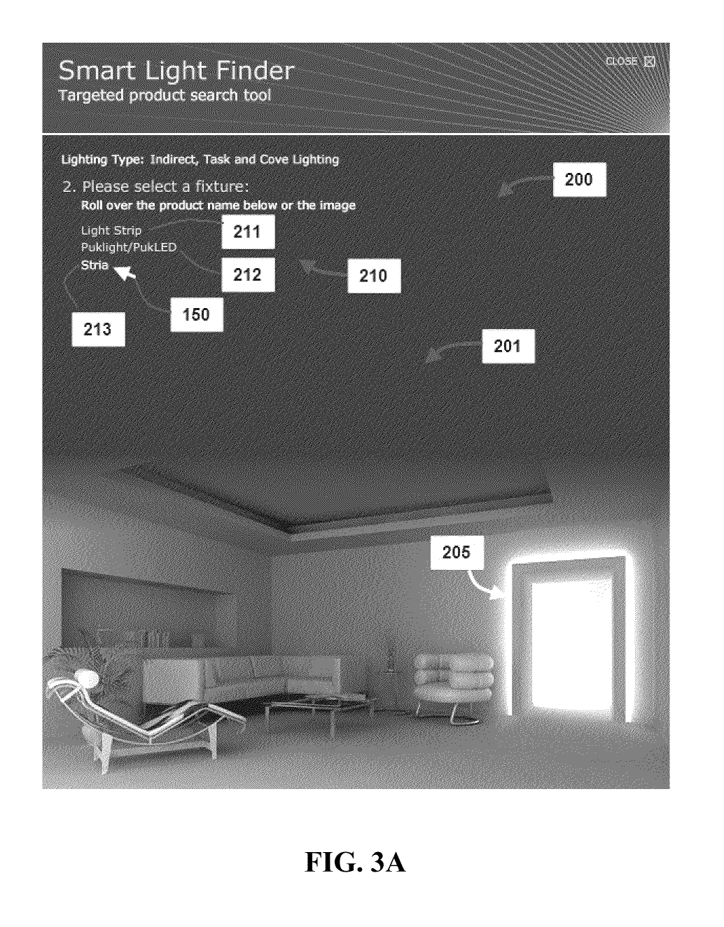

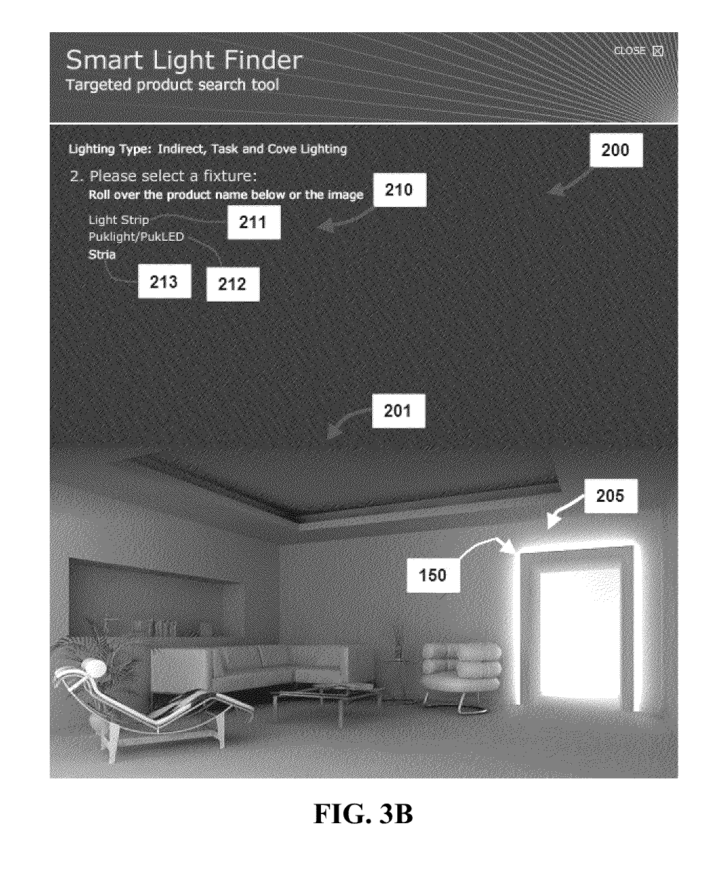

In exemplary embodiments, a user may manipulate the input device in one of two ways to view the lighting effects provided when a lighting device is in an illuminated state. For example, as shown in FIG. 3A, a user can direct the cursor to an area proximal to designation 213 (corresponding to the “Stria” lighting device). When the user directs the cursor in this manner, the entry in listing 210 corresponding to the lighting device will be altered (e.g., by changing a characteristic of the text or font, including for example, the size and/or color). In addition, interactive display 200 will also display a lighting effect 205 provided by a lighting device corresponding to the designation for the “Stria” lighting device.

As shown in FIG. 3B, a user may also manipulate the input device to direct cursor 150 to an area proximal to the area where lighting effect 205 from the Stria lighting device will be displayed. When the user directs cursor 150 to an area proximal to this area (e.g., proximal to an area in environmental rendition 201 corresponding to where the Stria lighting device would typically be located), lighting effect 205 is displayed in environmental rendition 201. In addition, entry 213 will also be altered so that the user knows which entry in listing 210 corresponds to the lighting device associated with lighting effect 205.

It is understood that certain lighting devices may be concealed from view in normal use. Therefore, the actual lighting device may not be portrayed in an environmental rendition according to the system. However, a user may view the lighting effect provided by a lighting device by directing cursor 150 to an area proximal to where the lighting device would typically be located. A user may view environmental rendition 201 and move cursor 150 to various positions within environmental rendition 201 in order to determine the different lighting effects.

As explained above, a user may therefore view lighting effect 205 of a lighting device by manipulating the input device to place cursor 150 in an area proximal to either the designation for the lighting device (provided in listing 210) or proximal to the location of the lighting device in interactive display 200. A user therefore does not have to be familiar with the terminology used to identify a particular lighting device in order to view the lighting effect provided by the device. Interactive display 200 allows a user to view on a single screen the name or designation of the lighting device, as well as the lighting effect of the device when it is in an illuminated state.

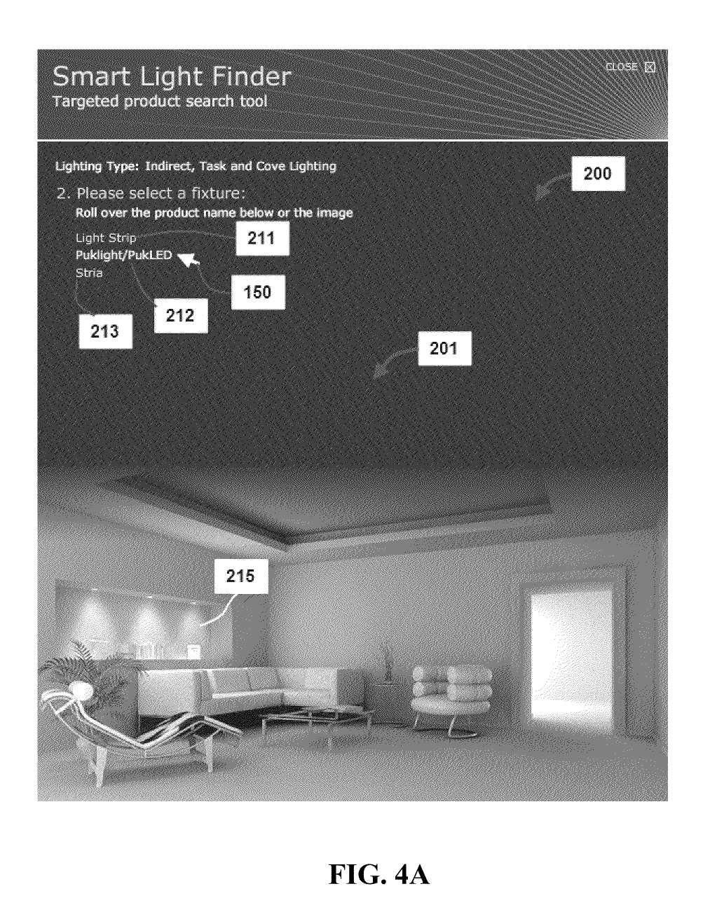

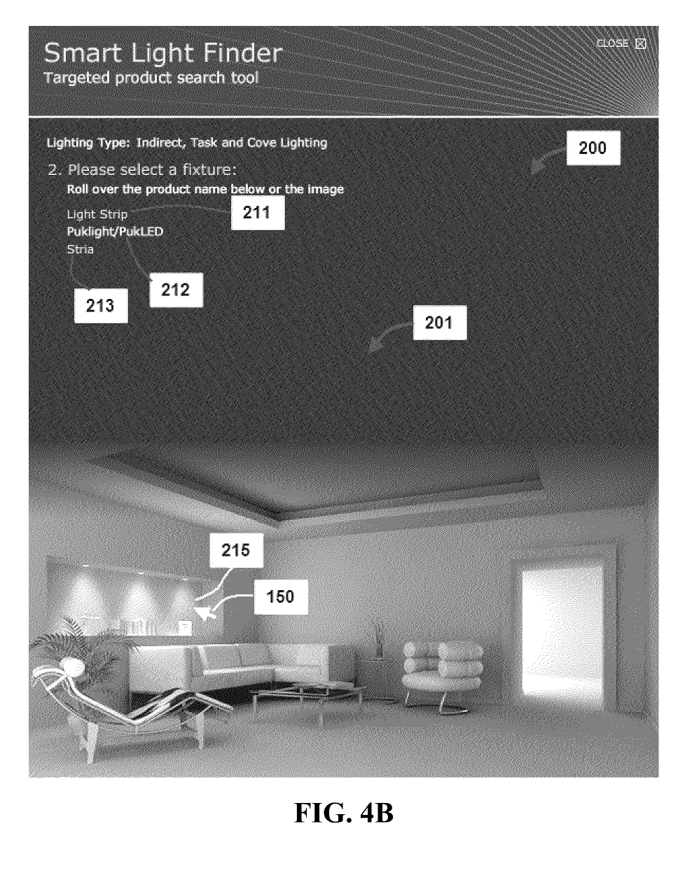

Referring now to FIG. 4A, a user has positioned cursor 150 proximal to designation 212 for “Puklight/PukLED”. In response to cursor 150 being so positioned, lighting effect 215 (the lighting effect provided when the lighting devices corresponding to designation 212 are illuminated) is displayed in environmental rendition 201. In addition, a characteristic (e.g., color, size, font, etc.) of designation 212 is altered so that a user can easily associate designation 212 with lighting effect 215.

Referring now to FIG. 4B, a user has positioned cursor 150 proximal to the area where lighting effect 215 from the Puklight/PukLED lighting device will be displayed. When the user directs cursor 150 to an area proximal to this area (e.g., proximal to an area in environmental rendition 201 corresponding to where the Puklight/PukLED lighting device would typically be located), lighting effect 215 is displayed in environmental rendition 201. In addition, entry 212 will also be altered so that the user knows which entry in listing 210 corresponds to the lighting device associated with lighting effect 215.

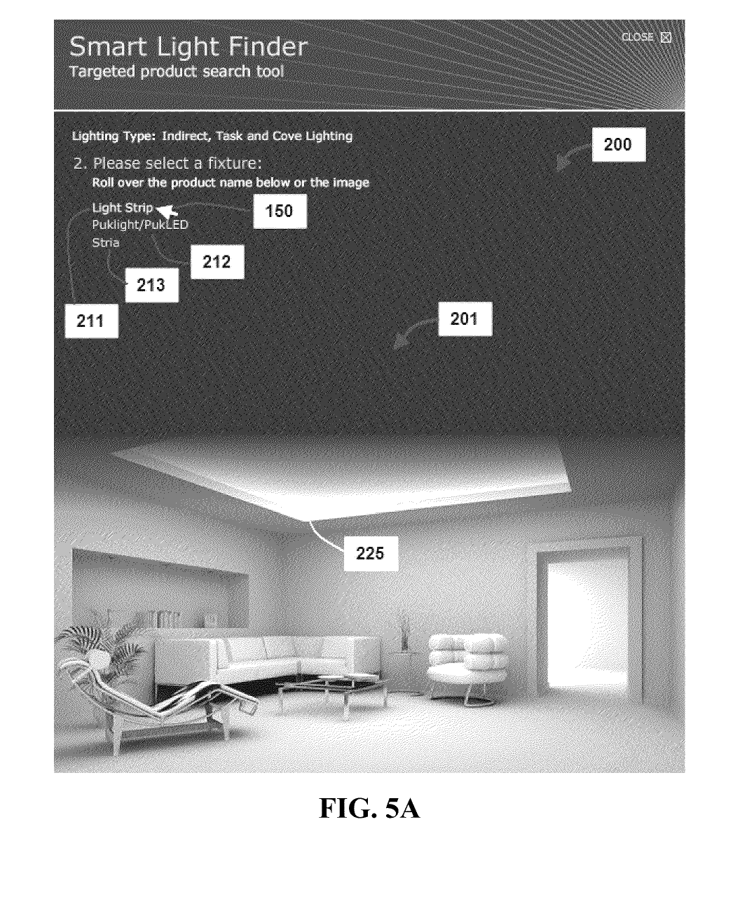

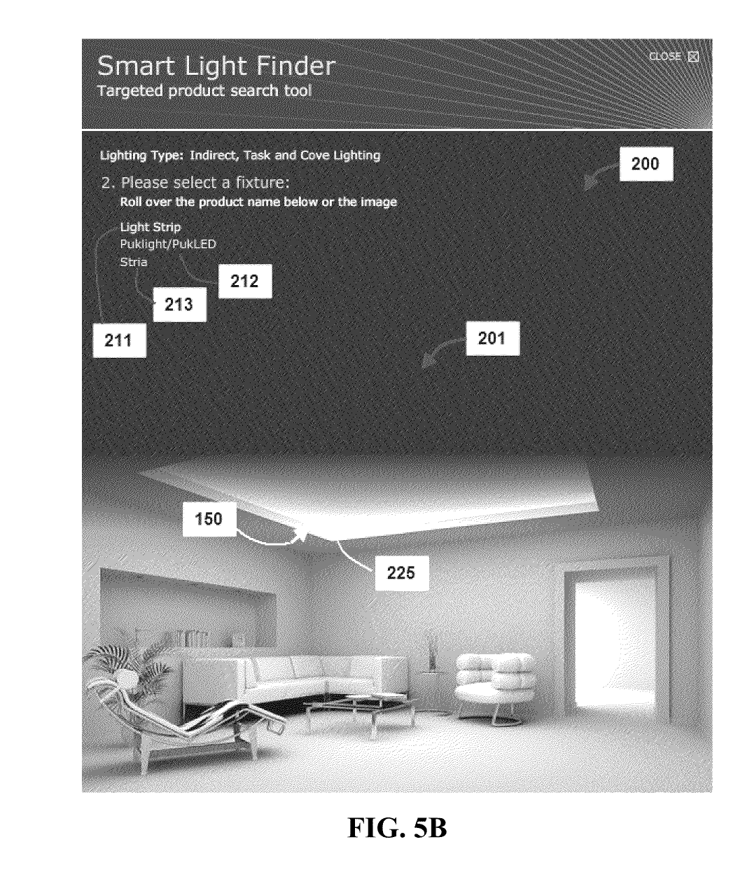

Referring now to FIG. 5A, a user has positioned cursor 150 proximal to designation 211 for “Light Strip”. In response to cursor 150 being so positioned, lighting effect 225 (the lighting effect provided when the lighting devices corresponding to designation 211 are illuminated) is displayed in environmental rendition 201. In addition, a characteristic (e.g., color, size, font, etc.) of designation 211 is altered so that a user can easily associate designation 211 with lighting effect 225.

Referring now to FIG. 5B, a user has positioned cursor 150 proximal to the area where lighting effect 225 from the Light Strip lighting device will be displayed. When the user directs cursor 150 to an area proximal to this area (e.g., proximal to an area in environmental rendition 201 corresponding to where the Light Strip lighting device would typically be located), lighting effect 225 is displayed in environmental rendition 201. In addition, entry 211 will also be altered so that the user knows which entry in listing 210 corresponds to the lighting device associated with lighting effect 215.

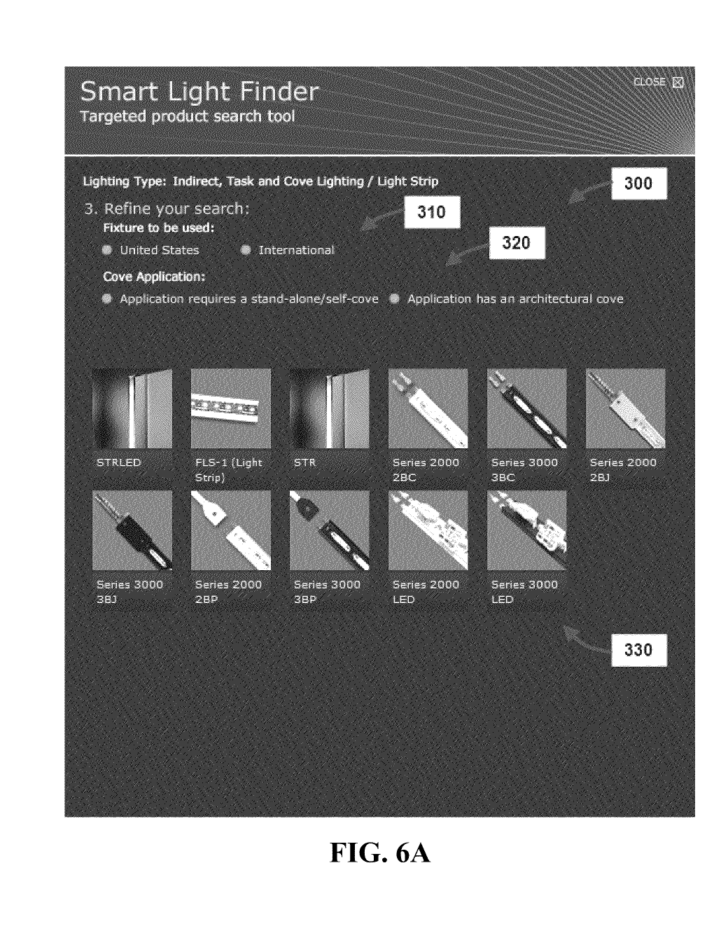

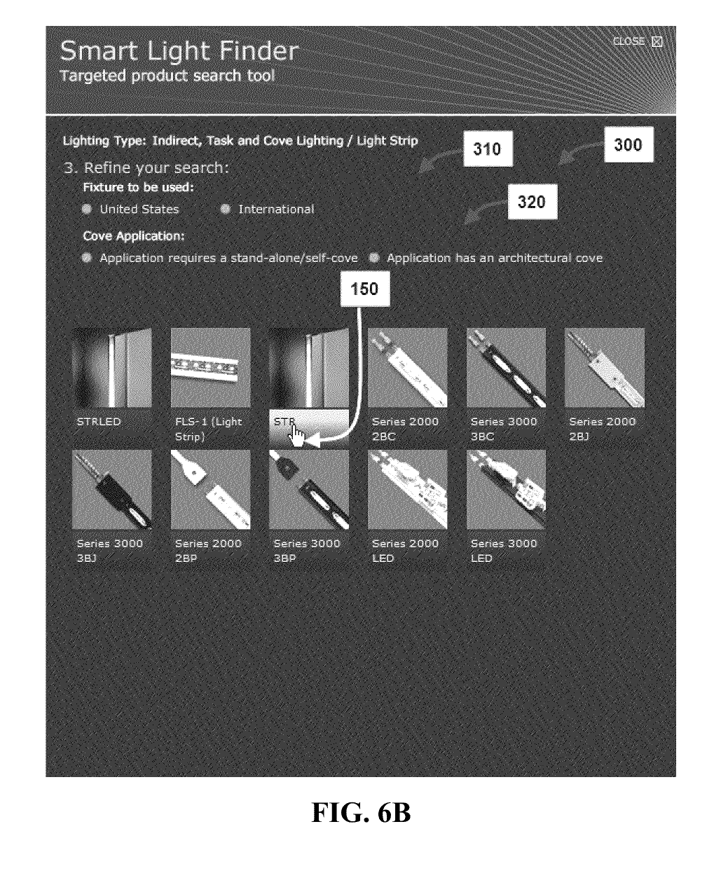

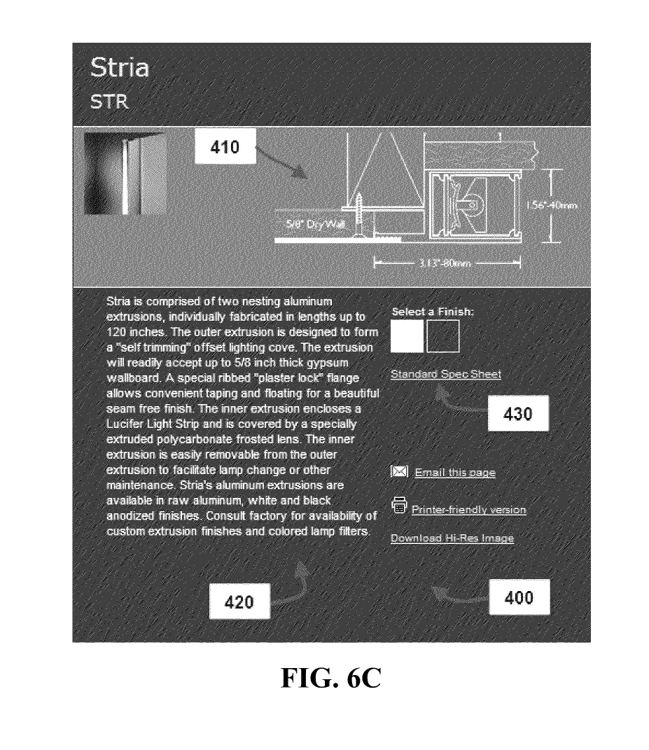

A user may select a specific type of lighting device, e.g., by clicking on a mouse when cursor 150 is proximal to a designation for the lighting device or when cursor 150 is proximal to the lighting effect provided by the lighting device in an environmental rendition. For example, a user may select a “Light Strip” lighting device in FIG. 5A or 5B. After a user selects a Light Strip lighting device, interactive display 200 will be replaced with interactive display 300, as shown in FIG. 6A. Interactive display 300 comprises a listing of various specifications that a user may define to further narrow a list of potential lighting devices that are suitable for the user's application. In the embodiment shown in FIG. 6, interactive display 300 comprises a geographic specification 310 that includes allows a user to specify the United States or International applications. Interactive display 300 may also comprise an application specification 320 that allows a user to select a lighting device for applications requiring a stand-alone/self-cove and for applications using an architectural cove. It is understood that other embodiments may provide for different specifications than those depicted in FIG. 6.

Also shown in FIG. 6 are a series of illustrations 330 depicting specific examples of lighting devices for the category of light selected from interactive display 200. A user may select a specific lighting device illustrated in FIG. 6 in the manner previously described (e.g., by positioning cursor 150 proximal to the desired selection and manipulating an input device to make the selection). As shown in FIG. 6B, a user is preparing to make a selection for the “STR” lighting device. After the “STR” lighting device is selected, interactive display 300 is replaced with interactive display 400, as shown in FIG. 6C. Interactive display 400 comprises details regarding the previously selected lighting device. For example, interactive display 400 may comprise dimensional drawings 410, a description of features 420, and a link 430 to a specification sheet (as well as other details).

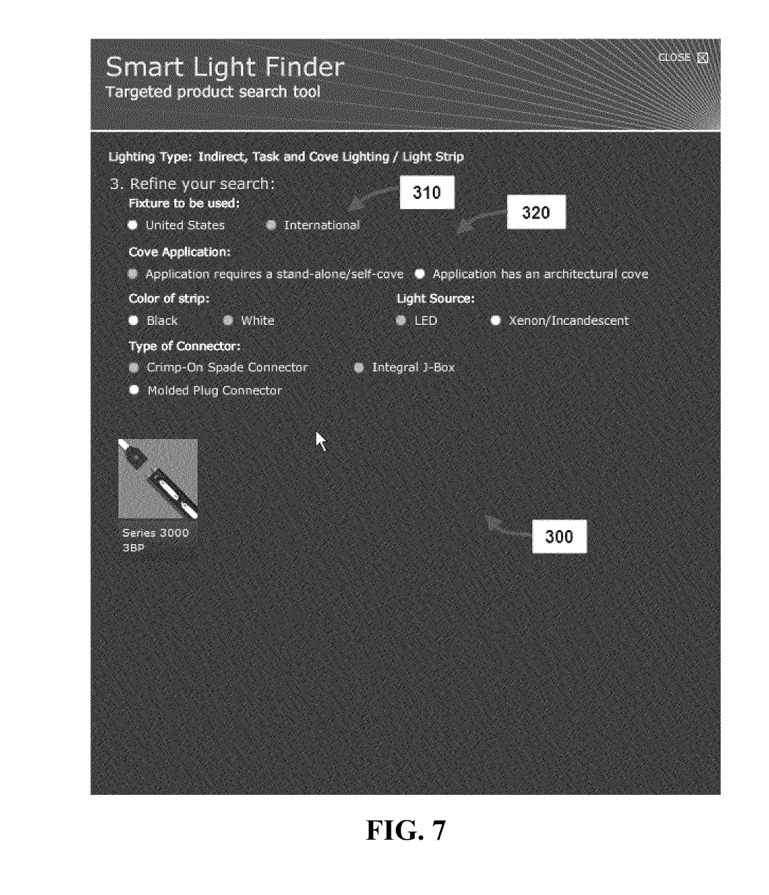

In addition to selecting a lighting device directly from the series of illustrations 330 as shown in FIG. 6B, a user may instead choose to make selections for certain specifications to narrow the list of suitable lighting devices. As shown in FIG. 7, if a user selects “United States” for geographic specification 310 and “Application has an architectural cove” for application specification 320, additional specifications will also be displayed (for example, the color of the lighting device, the light source, and the type of connector). A user may therefore narrow down the number of suitable lighting devices by selecting certain specifications.

The systems and methods are not intended to be limited to the particular forms disclosed. Rather, they include all modifications, equivalents, and alternatives falling within the scope of the claims.

Embodiments of the present techniques may be coded as software stored on any suitable computer readable media (e.g., tangible computer readable media) to form the present systems and methods, such as any suitable form of memory or data storage device, including but not limited to hard drive media, optical media, RAM, SRAM, DRAM, SDRAM, ROM, EPROM, EEPROM, tape media, cartridge media, flash memory, memory stick, and/or the like. Tangible computer readable media includes any physical medium that can store or transfer information. Such embodiments may be characterized as tangible computer readable media having (or encoded with) computer executable (e.g., machine readable) instructions for performing certain step(s). The term “tangible computer readable medium” does not include wireless transmission media, such as carrier waves. The term “computer readable medium,” however, does cover wireless transmission media, and some embodiments of the present methods may include wireless transmission media carrying the computer readable instructions described above. The software can be written according to any technique known in the art. For instance, the software may be written in any one or more computer languages (e.g., ASSEMBLY, PASCAL, FORTRAN, BASIC, C, C++, C#, JAVA, Perl, Python) or using scientific packages like, but not limited to, Matlab®, R, S-plus®, and SAS®. The code may be to enable it to be compiled on all common platforms (e.g., Microsoft®, Linux®, Apple Macintosh® OS X, Unix®). Further, well-established cross-platform libraries such as OpenGL® may be utilized to execute embodiments of the present methods, devices and systems. Multi-threading may be used wherever applicable to reduce computing time on modern single- and multi-processor based hardware platforms. As discussed above and illustrated in the figures, the software may include a graphical user interface (GUI) display, which may provide a user with a more intuitive feel when running the software. Different fields may be accessible by screen touching, a mouse and/or keyboard. Alarms, cues, and the like may be done via pop-up windows, audible alerts, or any other techniques known in the art.

Some (up to all) of the functions described above may be implemented using a computer having a processor (e.g., one or more integrated circuits) programmed with firmware and/or running software. Some (up to all) of the functions described above may be implemented using a distributed computing environment, which is one example of a computer system. In a distributed computing environment, multiple computers may be used, such as those connected by any suitable number of connection mediums (e.g., a local area network (LAN), a wide area network (WAN), or other computer networks, including but not limited to Ethernets, enterprise-wide computer networks, intranets and the Internet, and the connections between computers can be wired or wireless). Servers and user terminals can be part of a given computer system. Furthermore, embodiments of suitable computer systems may be implemented on application specific integrated circuits (ASICs) or very large scale integrated (VLSI) circuits, and further (or alternatively) may be configured to use virtualization of resources, virtual computing, and/or cloud computing to achieve the specified functions. In fact, persons of ordinary skill in the art may utilize any number of suitable structures capable of executing logical operations in order to achieve the functions described above in a computer system consistent with this disclosure.

Descriptions of well known processing techniques, components and equipment have been omitted so as not to unnecessarily obscure the present methods, devices and systems in unnecessary detail. The descriptions of the present methods, devices and systems are exemplary and non-limiting. Certain substitutions, modifications, additions and/or rearrangements falling within the scope of the claims, but not explicitly listed in this disclosure, may become apparent to those of ordinary skill in the art based on this disclosure. Furthermore, it will be appreciated that in the development of a working embodiment, numerous implementation-specific decisions must be made to achieve the developers' specific goals, such as compliance with system-related and business-related constraints, which will vary from one implementation to another. While such a development effort might be complex and time-consuming, it would nonetheless be a routine undertaking for those of ordinary skill in the art having the benefit of this disclosure.

The appended claims are not to be interpreted as including means-plus-function limitations, unless such a limitation is explicitly recited in a given claim using the phrase(s) “means for” and/or “step for,” respectively.

1. A computer system configured to provide:
an interactive display;
a cursor;
a lighting device designation; and
an environmental rendition, wherein:
the interactive display is configured to display a lighting effect;
the lighting effect is displayed when the cursor is in a first position; and
the lighting effect is not displayed when the cursor is in a second position.

2. The computer system of claim 1, wherein the first position is proximal to the lighting device designation.

3. The computer system of claim 1, wherein the first position is proximal to an area where the lighting effect will be displayed.

4. The computer system of claim 1, wherein the first position is proximal to either the lighting device designation or to the area where the lighting effect will be displayed.

5. The computer system of claim 1, wherein the lighting device designation is part of a listing of a plurality of lighting device designations.

6. The computer system of claim 1, wherein the interactive display is configured to display a plurality of lighting effects.

7. The computer system of claim 1, wherein the system is configured such that a user can select the lighting device designation to view a specification display comprising a set of specifications regarding a plurality of lighting devices corresponding to the lighting device designation.

8. The computer system of claim 7, wherein the system is configured such that a user can select certain specifications to reduce the number of lighting devices in the plurality of lighting devices corresponding to the lighting device designation.

9. A computer system configured to provide:
a first interactive display including a cursor and a designation for a category of lighting devices; and
a second interactive display providing a rendition of an environment, wherein:
the second interactive display is displayed when a user positions the cursor proximal to the category of lighting devices and selects the category of lighting devices;
the second interactive display comprises a lighting device designation; and
the second interactive display is configured to display a lighting effect from a lighting device, wherein the lighting effect is displayed when the cursor is in a first position and wherein the lighting effect is not displayed when the cursor is in a second position.

10. The computer system of claim 9, wherein the first position is proximal to the designation corresponding to a lighting device.

11. The computer system of claim 9, wherein the first position is proximal to an area where the lighting effect will be displayed.

12. The computer system of claim 9, wherein the first position is proximal to either the designation corresponding to a lighting device or to the area where the lighting effect will be displayed.
